(19) United States
(12) Patent Application Publication
(10) Pub. No.: US 2026/0145425 A1
(43) Pub. Date: May 28, 2026

(54) LIQUID EJECTION HEAD, METHOD, AND DEVICE

(71) Applicant: RISO Technologies Corporation, Tokyo (JP)

(72) Inventor: Mengfei WONG, Mishima Shizuoka (JP)

(21) Appl. No.: 19/263,417

(22) Filed: Jul. 8, 2025

(30) Foreign Application Priority Data
Nov. 27, 2024 (JP) 2024-206335

(51) Int. Cl. B41J 2/045

(52) U.S. Cl. CPC B41J 2/04588; B41J 2/04581; B41J 2/04591; B41J 2/04596

(57) ABSTRACT

A liquid ejection head includes a nozzle, a pressure chamber that communicates with the nozzle, a volume of the chamber being varied to eject liquid from the nozzle, an actuator configured to vary the volume in response to a drive signal, and a drive circuit configured to generate the signal. The signal includes n ejection waveforms each including an ejection pulse including an expansion portion and a contraction portion. At least one of the ejection waveforms includes a damping pulse that is subsequent to the ejection pulse and includes a contraction portion and an expansion portion. The ejection waveforms include consecutive ejection waveforms that are separated by an intermediate time period that is in a range of 0.2 times or more and 2 times or less a half cycle of a natural vibration period of the liquid in the chamber.

### CROSS-REFERENCE TO RELATED APPLICATION

This application is based upon and claims the benefit of priority from Japanese Patent Application No. 2024-206335, filed on Nov. 27, 2024, the entire contents of which are incorporated herein by reference.

### FIELD

Embodiments described herein relate to a drive device.

### BACKGROUND

A liquid ejection head such as an ink jet head mounted on an ink jet printer is known. The ink jet printer ejects ink droplets from the ink jet head to form an image or the like on the surface of a recording medium. The ink jet head ejects ink droplets from a nozzle that communicates with a pressure chamber by changing the volume of the pressure chamber with a piezoelectric actuator. The operation of the actuator is controlled by a drive waveform input to the actuator.

In the liquid ejection head, a multi-drop drive, which ejects ink droplets a plurality of times, is employed to expand the gradation expression range and ensure ejection stability. Immediately after the ejection, the ink droplets remain connected to ink inside the nozzle and leave a tail. When a portion of the tail (hereinafter referred to as the liquid column) breaks, an additional droplet distinct from the main ejected droplet may be generated. Satellite mist produced when the liquid column collapses, degrading print quality due to landing irregularities.

In such a liquid ejection head, when printing is performed by ejecting ink n times (n is an integer of 3 or more), a drive waveform can suppress satellite mist by providing an intermediate time of 4 acoustic length (hereinafter referred to as AL) or more between the drive waveform for ejecting the (n−1)-th drop of ink and the drive waveform for ejecting the n-th drop of ink, but if the intermediate time is too long, the upper limit of the ejection frequency decreases. The AL is defined as half cycle of a natural vibration period of the liquid in the pressure chamber.

### BRIEF DESCRIPTION OF THE DRAWINGS

FIG. 1 is a diagram of a liquid ejection device according to an embodiment.

FIG. 2 is a diagram of a liquid ejection head according to an embodiment.

FIG. 3 is a diagram showing a basic ejection waveform.

FIG. 4 is a diagram showing a drive waveform.

FIG. 5 is a diagram showing printing characteristics in drive waveforms according to an embodiment and Comparative Example 1.

FIG. 6 is a diagram showing a drive waveform according to another embodiment.

FIG. 7 is a diagram showing a basic drive waveform according to Comparative Example 1.

FIG. 8 is a diagram of pressure chambers and piezoelectric elements.

### DETAILED DESCRIPTION

A liquid ejection head, method, and device capable of maintaining an ejection frequency while preventing mist are provided.

In general, according to one embodiment, a liquid ejection head comprises a nozzle plate including a nozzle; a pressure chamber that is capable of storing liquid and communicates with the nozzle, a volume of the pressure chamber being varied to eject the liquid from the nozzle; an actuator configured to vary the volume of the pressure chamber in response to a drive signal; and a drive circuit configured to generate the drive signal. The drive signal includes n ejection waveforms (n is an integer of 2 or more), each including an ejection pulse for ejecting the liquid. The ejection pulse includes an expansion portion for expanding the volume of the pressure chamber and a contraction portion that is subsequent to the expansion portion for contracting the volume of the pressure chamber. At least one of the ejection waveforms includes a damping pulse that is subsequent to the ejection pulse and includes a contraction portion for contracting the volume of the pressure chamber and an expansion portion that is subsequent to the contraction portion for expanding the volume of the pressure chamber. The ejection waveforms include consecutive ejection waveforms that are separated by an intermediate time period that is in a range of 0.2 times or more and 2 times or less a half cycle of a natural vibration period of the liquid in the pressure chamber.

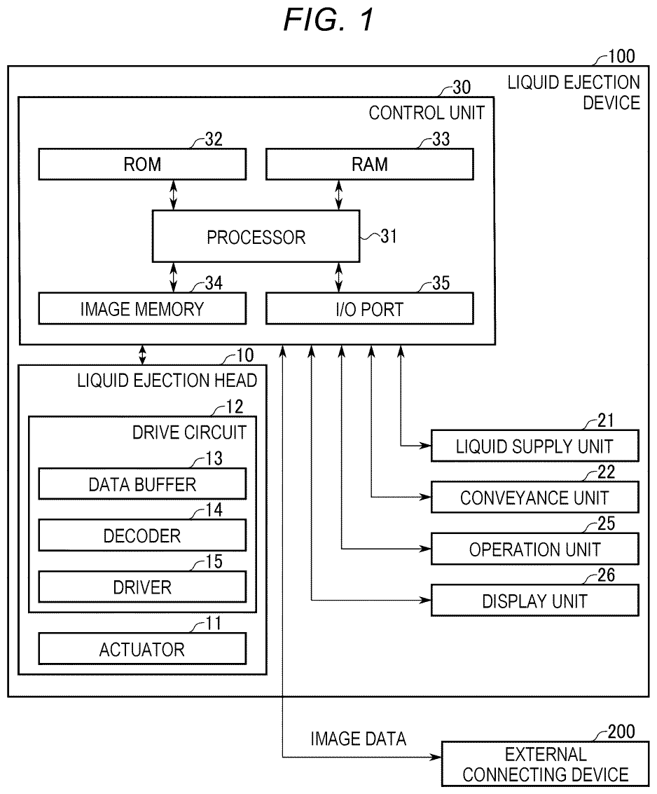

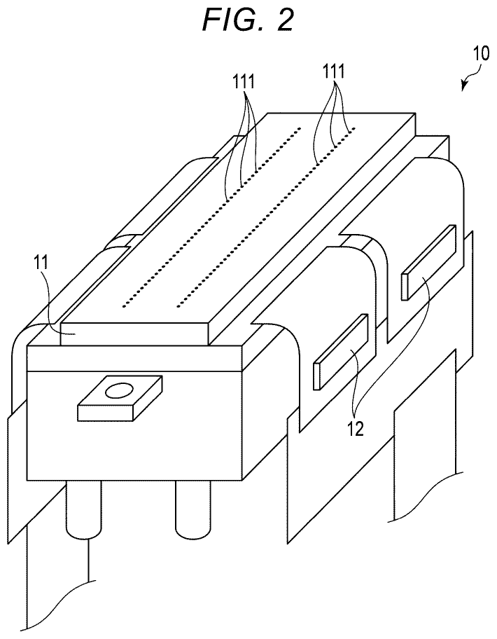

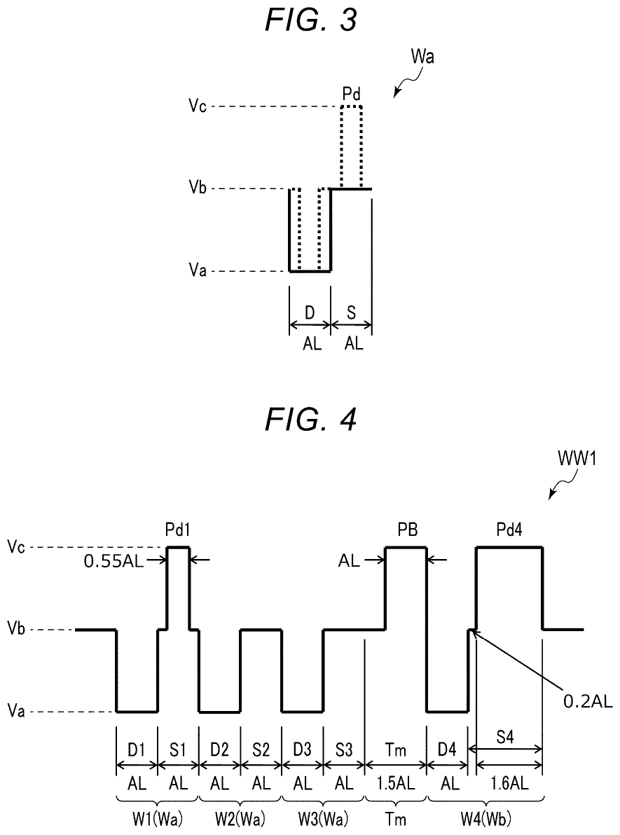

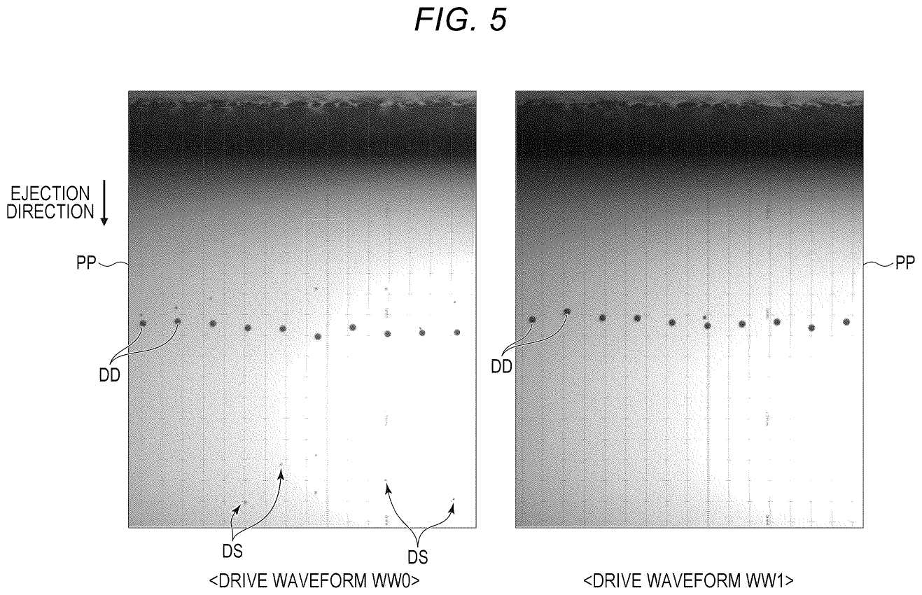

A liquid ejection head 10 (hereinafter also referred to as the drive device) and a liquid ejection device 100 according to embodiments will be described below with reference to FIGS. 1 to 5. FIG. 1 is a block diagram of the liquid ejection device 100, and FIG. 2 is a perspective view of the liquid ejection head 10. FIG. 3 is a diagram showing a basic ejection waveform of a drive waveform according to an embodiment, and FIG. 4 is a diagram showing the drive waveform according to an embodiment. FIG. 5 is a diagram showing printing characteristics in drive waveforms according to an embodiment and Comparative Example 1.

As shown in FIG. 1, the liquid ejection device 100 includes the liquid ejection head 10, a liquid supply unit 21, a conveyance unit 22, an operation unit 25, a display unit 26, and a control unit 30.

The liquid ejection device 100 is an ink jet printer that performs an image forming process on a medium such as paper by ejecting liquid such as ink from the liquid ejection head 10 while conveying the medium such as paper as an ejection target along a predetermined conveyance path passing at a printing position facing the liquid ejection head 10.

The liquid ejection head 10 shown in FIG. 2 is, for example, a shear-mode shared-wall type ink jet head. The liquid ejection head 10 may be a non-recirculation type head that does not recirculate ink, or may be a recirculation type head that recirculates ink. In the present embodiment, the liquid ejection head 10 will be described using the example of the non-recirculation type head.

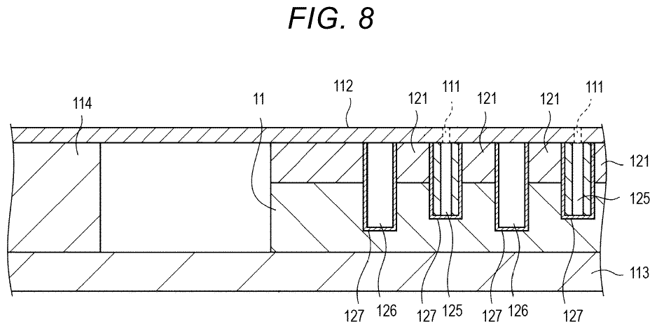

For example, as shown in FIG. 8, the liquid ejection head 10 includes an actuator 11 including a plurality of piezoelectric elements 121 formed between a nozzle plate 112 and a substate 113, and a drive circuit 12 that drives the actuator 11.

The liquid ejection head 10 includes a plurality of pressure chambers 125 and dummy chambers 126, each of which is connected to an electrode 127. The flow path of the liquid ejection head 10 is formed by a frame 114 and connected to the liquid supply unit 21, and the ink is supplied from the liquid supply unit to the flow path of the liquid ejection head 10. The actuator 11 applies a voltage to electrodes 127 of the piezoelectric elements 121 provided corresponding to the pressure chambers 125 to deform the piezoelectric elements 121, so that volumes of the pressure chambers 125 are increased or decreased to eject the ink from the nozzles 111.

The drive circuit 12 drives the actuator 11 by applying a drive voltage to the electrodes of the piezoelectric elements 121. The drive circuit 12 generates a control signal and a drive signal for operating the piezoelectric elements 121. The drive circuit 12 generates the control signal for controlling a timing of ejecting liquid and selection of the piezoelectric element 121 to eject liquid according to an image signal received from the control unit 30 of the ink liquid ejection device 100. In addition, the drive circuit 12 generates a voltage to be applied to the electrodes of the piezoelectric elements 121, that is, the drive signal, according to the control signal. When the drive circuit 12 applies the drive signal to the piezoelectric element 121, the piezoelectric element 121 is driven to change the volume of the pressure chamber 125. That is, the actuator 11 can perform drive control under the control of the control unit 30.

As shown in FIG. 1, the drive circuit 12 includes a data buffer 13, a decoder 14, and a driver 15. The data buffer 13 stores printing data in time series for each piezoelectric element 121 of the actuator 11. The decoder 14 controls the driver 15 based on the printing data stored in the data buffer 13 for each piezoelectric element 121. The driver 15 outputs the drive signal for operating the piezoelectric elements 121 based on the control of the decoder 14. The drive signal is a voltage to be applied to the electrodes of the piezoelectric elements 121.

The liquid supply unit 21 is connected to a primary side of the flow path of the liquid ejection head 10, and supplies the liquid to the flow path of the liquid ejection head 10. For example, the liquid supply unit 21 includes a tank that stores the liquid, a connection flow path that connects the tank and the flow path of the liquid ejection head 10, and a liquid sending pump that sends the liquid in the tank to the liquid ejection head 10.

The conveyance unit 22 conveys a medium such as paper along a predetermined conveyance path and supplies the medium to a printing position. The conveyance unit 22 includes, for example, a plurality of conveyance rollers and conveyance guides disposed along the conveyance path. The conveyance unit 22 supports the medium such that the medium can be moved relative to the liquid ejection head 10.

The operation unit 25 includes function keys such as a power key, a paper feed key, and an error release key.

The display unit 26 includes a display capable of displaying various states of an image printing device.

The control unit 30 is, for example, a control board, and includes a processor 31, a read only memory (ROM) 32, a random access memory (RAM) 33, an image memory 34, and an I/O port 35, which is an input and output port.

The processor 31 is a processing circuit such as a central processing unit (CPU). The processor 31 controls the components of the liquid ejection device 100 to perform various functions of the printer according to an operating system and application programs. For example, the processor 31 controls operations of the liquid ejection head 10, the liquid supply unit 21, and the conveyance unit 22 that are provided in the liquid ejection device 100. During printing, the processor 31 transmits the printing data stored in the image memory 34 to the drive circuit 12 in a drawing order.

The ROM 32 stores the above operating system and the application programs. The ROM 32 may store data necessary for the processor 31 to execute processing for controlling the units.

The RAM 33 stores data necessary for the processor 31 to execute processing. The RAM 33 is also used as a work area in which information is appropriately rewritten by the processor 31. The work area may include an image memory in which the printing data is loaded.

The image memory 34 stores, for example, the printing data from an external connecting device 200.

The I/O port 35 is an interface circuit that receives data from the external connecting device 200 and outputs data to the outside. The printing data from the external connecting device 200 is transmitted to the control unit 30 through the I/O port 35, and is stored in the image memory 34.

The printing data is data to be input to the liquid ejection head 10, and is converted from image data or the like including information on a color and a density image of each region to eject the liquid. For example, as a part of the printing data, information of the AL of the liquid ejection head 10 may be included as a reference related to an ejection speed at a predetermined ejection volume. For example, the AL of the liquid ejection head 10 is input through the external connecting device 200, input as a part of information for setting a drive waveform, and recorded.

Then, the liquid ejection head 10 sets a drive waveform based on the printing data including the AL, and applies the drive waveform to the actuator 11. That is, in the present embodiment, the liquid ejection head 10 serves as a drive device that adjusts an intermediate time of the drive waveform based on the AL.

In the liquid ejection device 100 having such a configuration, the control unit 30 inputs a signal to the liquid ejection head 10 to apply the drive voltage to the drive circuit 12, generates a potential difference between the plurality of piezoelectric elements 121 of the actuator 11, selectively deforms the piezoelectric elements 121, and increases or decreases the volumes of the pressure chambers 125, thereby ejecting the liquid from the nozzles 111. For example, when the volume of the pressure chamber 125 is expanded or contracted during driving, a pressure vibration occurs in the pressure chamber 125. Due to the pressure vibration, a pressure inside the pressure chamber 125 increases, and ink droplets are ejected from the nozzles 111 communicating with the pressure chamber 125. For example, according to the signal received from the control unit 30, the driver 15 applies the drive voltage to the electrodes of the pressure chambers 125, thereby generating the potential difference between the plurality of piezoelectric elements 121, selectively deforming the piezoelectric elements 121, and changing the volumes of the pressure chambers 125. For example, when the voltage serving as an expansion element is applied, the piezoelectric element 121 is deformed, the volume of the corresponding pressure chamber 125 increases, the pressure decreases, and the ink in the common chamber flows into the corresponding pressure chamber 125. When a drive voltage of a reverse potential is applied to the electrode of the piezoelectric element 121 in a state in which the volume of the pressure chamber 125 is increased, the piezoelectric element 121 is deformed to decrease the volume of the pressure chamber 125, and the pressure increases. Therefore, the ink in the pressure chamber 125 is pressurized and ejected from the nozzle 111.

As shown in FIG. 5, in the liquid ejection device 100, when liquid is ejected while the liquid ejection head 10 is moved relative to the medium PP along a conveyance direction, a plurality of dots DD are formed on the medium PP.

Hereinafter, characteristics of the liquid ejection head 10 used in the liquid ejection device 100 and a drive waveform according to the drive signal generated by the drive circuit 12 of the liquid ejection head 10 will be described. For example, the liquid ejection head 10 employs a multi-drop drive, and can be driven in a plurality of gradations by combining a plurality of drop waveforms. That is, the drive circuit 12 drives with a multi-gradation drive waveform by multi-drop signals having a plurality of patterns or types. Specifically, a condition of the drive waveform is set for each piezoelectric element 121. In the setting of the drive waveform, a drive pattern may be selected for each element from a plurality of patterns set and stored in advance. In the drive method of the liquid ejection device 100, a liquid ejection unit is driven by the drive waveform WW1 to eject n drops of droplets (n is an integer of 2 or more).

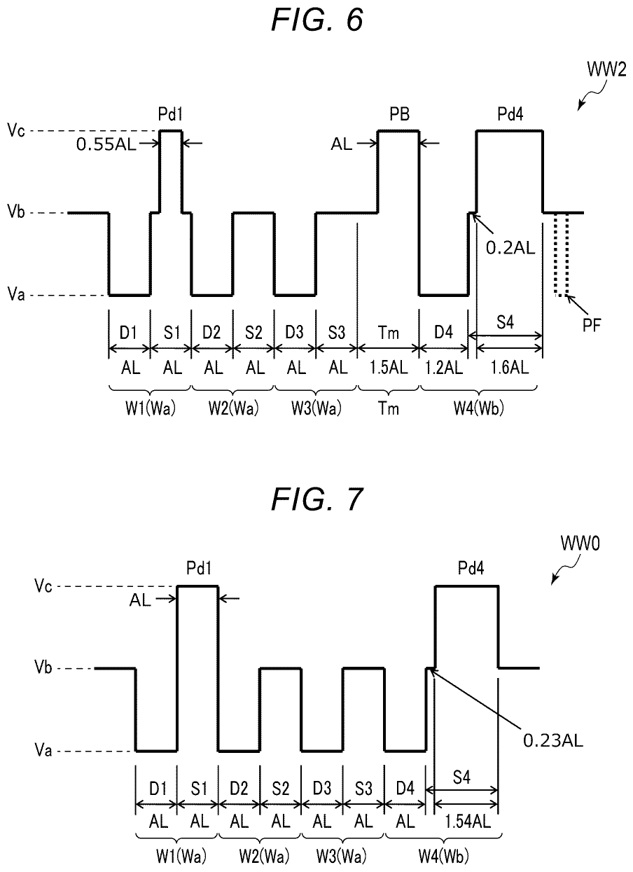

Drive waveforms according to the drive signal generated by the drive circuit 12 of the liquid ejection head 10 will be described with reference to FIGS. 3, 4, 5 and 7. FIG. 3 shows a basic ejection waveform Wa used for the drive waveform WW1 according to Example 1 of the embodiment. FIG. 4 shows the drive waveform WW1 according to Example 1. FIG. 5 is a diagram showing printing characteristics in a drive waveform according to the embodiment and a drive waveform WW0 according to Comparative Example, and FIG. 6 is a diagram showing a drive waveform WW2 according to Example 2. FIG. 7 shows the drive waveform WW0 according to Comparative Example. In each waveform diagram, a horizontal axis represents a time, and a vertical axis represents a voltage.

FIG. 4 shows the drive waveform WW1. The drive waveform WW1 is an example of a multi-drop drive waveform for forming one dot by ejecting ink n times (n is an integer of 2 or more) in a drive cycle of one cycle. Waveform data of the drive waveform WW1 is stored in, for example, a memory in the drive circuit 12.

The drive waveform to be input to the actuator 11 may be set or selected by the driver 15 of the drive circuit 12 based on gradation data transmitted from the control unit 30.

The drive waveform WW1 is the multi-drop drive, and includes a plurality of ejection waveforms.

The drive waveform WW1 is a waveform having four drops, and has four ejection waveforms W1 to W4 each including the expansion element and a contraction element. That is, the drive waveform WW1 is a drive waveform having a maximum of four drop waveforms or elements in one printing period, and is a waveform driven in a plurality of gradations, for example, five gradations.

Here, as an example, the multi-drop drive waveform (n=4) is exemplified in which the number of times of ejection in the drive cycle of one cycle is four drops, but the disclosure is not limited thereto. Periodic lengths T of the ejection waveforms W1, W2, and W3 from 1 to (n−1) are equal.

For example, the drive waveform WW1 is a multi-drop waveform in which, when one pixel is constituted by n drops (n>1), a first drop to a (n−1)-th drop are ejected with the basic ejection waveform Wa, which is a first ejection waveform, and a n-th drop which is a final drop is ejected with the final ejection waveform, which is a second ejection waveform. For example, the drive waveform WW1 includes the basic ejection waveform Wa from the first drop to the (n−1)-th drop and a final ejection waveform Wb, which is the second ejection waveform. The second ejection waveform is the ejection waveform of the n-th drop. That is, in the drive waveform WW1, the basic ejection waveform Wa is repeated n−1 times, and the final ejection waveform Wb is provided after an intermediate time Tm.

FIG. 3 is a diagram showing an example of the basic ejection waveform Wa. The basic ejection waveform Wa is a so-called pull-ejection drive waveform. The basic ejection waveform Wa includes, for example, an ejection pulse D (D1 to D3) having the expansion element that expands the pressure chamber 125 and the contraction element that contracts the pressure chamber 125. For example, the ejection pulse D decreases the voltage from a first voltage Vb, which is an intermediate voltage, to a second voltage Va lower than the first voltage Vb, which is the intermediate voltage, to expand the pressure chamber 125 (expansion element), and increases the voltage after continuing the second voltage Va for a predetermined time to contract the pressure chamber 125 (contraction element). In addition, the basic ejection waveform Wa includes a contraction waveform element S, which is in a contracted state for the predetermined time after being contracted by the ejection pulse D. Note that, in the contraction waveform element S (S1 to S3) after the ejection pulse D, the voltage may be maintained for the predetermined time in a state of returning to the first voltage Vb, which is the intermediate voltage. Alternatively, as indicated by a broken line in FIG. 3, the voltage may be further increased to a third voltage Vc higher than the intermediate voltage after the contraction to the first voltage Vb and returned to the first voltage Vb after the predetermined time elapses, so that the waveform includes a damping pulse Pd, in which the voltage changes in a stepwise manner.

Therefore, the drive waveform WW1 includes the ejection pulse D (D1 to D3) with the expansion element that expands the pressure chamber 125 and the contraction element that is set to the intermediate voltage after the expansion, and the contraction waveform element S (S1 to S3) after the ejection pulse D (D1 to D3), and includes the damping pulse Pd that contracts at the voltage higher than the intermediate voltage and returns to the intermediate voltage after the contraction in the contraction waveform element S (S1 to S3).

In the basic ejection waveform Wa, as indicated by the broken line in FIG. 3, the pulse width of the ejection pulse D may be set to be smaller than that of the AL.

As an example, each ejection waveform Wa is set to a time width that is twice the AL, whereby AL is a half period of the natural vibration period λ determined by characteristics of the ink and a structure in the head, and a width of the ejection pulse D in the basic ejection waveform Wa is set to the width of the AL. The intermediate voltage is, for example, 0 V, and is also referred to as a reference voltage. For example, a rectangular pulse waveform is exemplified, but the disclosure is not limited thereto, and a trapezoidal waveform may be used.

In the basic ejection waveforms Wa of 1 to (n−1) drop, other than the fourth and the final drop, the width of each pulse is the same, and is set to, for example, the AL. The width of each pulse may be the AL or a time shorter than the AL.

The AL is a half period of a natural vibration period λ determined by characteristics of the ink and the structure in the head. The length of the ejection waveform may be set to be larger than 2AL.

In the drive waveform WW1, the intermediate time Tm is provided between the ejection waveform of one of the drops and the ejection waveform of the next drop. For example, the intermediate time Tm is set between the ejection waveform for ejecting a droplet of the i-th drop (i≥1), which is one of the drops, and the ejection waveform for ejecting a droplet of the (i+1)-th drop, and is set between Si and D (i+1). As an example, the intermediate time Tm is provided between the final ejection waveform Wb of the final drop and the basic ejection waveform Wa of the (n−1)-th drop. Here, the intermediate time Tm is set to a time longer than an interval of the ejection waveform from the drop to the (n−1)-th drop. For example, the intermediate time Tm is set in a range of 0.2 times or more and 2 times or less the AL, or 0.2 times or more and less than 2 times the AL.

The drive waveform WW1 according to Example 1 may include a boost pulse PB immediately before D4, which is the ejection pulse of the final drop during the intermediate time Tm. The boost pulse PB is a pulse waveform including the contraction element that sets the voltage higher than the intermediate voltage and the expansion element that returns the voltage to the intermediate voltage after the contraction. As a specific example, the boost pulse PB increases the voltage from the first voltage Vb, which is the intermediate voltage, to the third voltage Vc, which is higher than the first voltage Vb, and returns the voltage to the first voltage Vb after the predetermined time elapses. For example, a pulse width of the boost pulse PB is preferably the AL, and may be set to a time shorter than the AL.

The final ejection waveform Wb is a so-called pull-ejection drive waveform. The final ejection waveform Wb includes, for example, the ejection pulse D (D4) including the expansion element that expands the pressure chamber 125 and the contraction element that contracts the pressure chamber 125. As a specific example, the ejection pulse D decreases the voltage from the first voltage Vb that is the intermediate voltage to the second voltage Va lower than the first voltage Vb to expand the pressure chamber 125 (expansion element), and increases the voltage after continuing the second voltage Va for the predetermined time to contract the pressure chamber 125 (contraction element). The final ejection waveform Wb includes a contraction waveform element S4 after the ejection pulse D4. The final ejection waveform Wb is a waveform in which the voltage changes in a stepwise manner, and includes a damping pulse Pd4 placed after, in sequential order, the contraction element of the ejection pulse D4 returning to the first voltage Vb, the predetermined time of S4 kept at the first voltage Vb, and the contraction waveform element of S4 further increasing the voltage to the third voltage Vc higher than the first voltage Vb.

That is, the final ejection waveform Wb includes the ejection pulse D (D4) including the expansion element that expands the pressure chamber 125 and the contraction element that is set to the intermediate voltage after the expansion, and the damping pulse Pd (Pd4) that contracts at the voltage higher than the intermediate voltage and returns the voltage to the intermediate voltage after the contraction. The final ejection waveform Wb is an ejection waveform having a pulse width longer than that of the basic ejection waveform Wa.

The intermediate damping pulse (Pdm) may be provided from the second drop to the (n−1)-th drop. The pulse widths of the damping pulse (Pd1) of the first drop, the intermediate damping pulse (Pdm) from the second drop to the (n−1)-th drop, and the damping pulse (Pdn) of the n-th drop satisfy Pdn>Pd1>Pdm≥0.

For example, in the drive waveform WW1, the damping pulses Pd are provided in the ejection waveform W1 of the first drop that ejects a first droplet and the final ejection waveform W4 of the fourth drop. The pulse widths of the damping pulses Pd satisfy Pd4>Pd1, and the width of the damping pulse Pd4 in the ejection waveform W4 is larger than the pulse width of the damping pulse Pd1 in the ejection waveform W1. Therefore, in the drive waveform WW1, the ejection waveform Wn of the n-th drop, which is the final drop, has a pulse width (time) longer than those of the ejection waveforms Wn of first to (n−1)-th drops.

In the present embodiment, the ejection waveform Wa from the second drop to the (n−1)-th drop is a waveform that does not include the damping pulse Pd and allows a predetermined time to elapse at the first voltage Vb after the contraction of the ejection pulse D. In this case, the pulse width of the damping pulse of the ejection waveform W from the second drop to the (n−1)-th drop is zero.

As an example, as shown in FIG. 4, in the ejection waveforms up to (n−1) which becomes the basic ejection waveform Wa, the pulse width of the ejection pulse D and the pulse width of the contraction waveform element S after the ejection pulse D are both AL. For example, the width of the damping pulse in the waveform of the first drop in the contracted state is 0.55 AL. The pulse width of the ejection pulse D4 of the final drop is also AL. In the contracted state of the ejection waveform of the last drop, the pulse width of the damping pulse Pd4 is 1.6 AL, and a holding time before the damping pulse Pd4 is 0.23 AL.

According to the liquid ejection head 10 and the liquid ejection device 100, it is possible to provide a drive device and a liquid ejection device capable of increasing an upper limit of a corresponding frequency while preventing satellite mist. That is, by providing the intermediate time Tm, it is possible to prevent mist. On the other hand, if the intermediate time Tm is provided, the ejection timing of the final drop is delayed, and if the intermediate time Tm is long, the corresponding frequency may decrease, but in the present embodiment, the corresponding frequency can be improved by setting the intermediate time Tm to 0.2 AL or more and 2.0 AL or less. In addition, by providing the boost pulse PB, it is possible to increase the ejection speed, merging a plurality of drops. Further, the vibration can be prevented by lengthening the damping pulse of the final drop.

Embodiments of this disclosure are not limited to the above-described configuration.

In the above configuration, an example is described in which the drive circuit 12 that drives the actuator 11 is provided in the liquid ejection head 10 and the liquid ejection head 10 itself serves as a drive device. Alternatively, for example, the liquid ejection head 10 or the liquid ejection device 100 may have a configuration in which the drive device is mounted. The drive waveform to be input to each actuator 11 may be set by the control unit 30, and for example, the waveform is set in a plurality of gradations for each nozzle.

In the above configuration, an example is described in which the intermediate time Tm is set between the ejection waveform for ejecting the droplet of the n-th drop, which is the final drop, and the ejection waveform for ejecting the droplet of the (n−1)-th drop, but the disclosure is not limited thereto. For example, the intermediate time Tm may be between the waveform element S1 and the ejection pulse D2 or between the waveform element S2 and the ejection pulse D3. That is, the intermediate time Tm is set between any two ejection waveforms. Note that, the intermediate time Tm is longer than the length between other ejection waveforms in which the intermediate time Tm is not provided.

In the above configuration, an example of 4-drop driving is described, but the disclosure is not limited thereto, and the number of drops may be 3 or less or 5 or more. Further, the drop waveforms is not limited to two types, and may be three or four or more types combined.

In the above configuration, the drive waveform for ejecting a maximum of four drops is described, but the disclosure is not limited thereto, and the drive waveform may be, for example, a drive waveform for ejecting a maximum of three drops or less or a maximum of five drops or more.

In the above configuration, an example is described in which the fourth drop which is the boost pulse PB is provided at the intermediate time Tm, but the disclosure is not limited thereto. In addition, specific conditions of each waveform can be appropriately changed, and for example, pulse widths may be different. A damping pulse Pd smaller than the initial damping pulse Pd1 and the final damping pulse Pdn may be provided in the ejection waveforms W2 and W3 other than the initial and final waveforms. In addition, the damping pulses Pd1 and Pd4 may not be provided in the first ejection waveforms W1 and the last ejection waveform W4.

For example, as in the drive waveform WW2 shown in FIG. 6 as another embodiment, a non-ejection pulse PF may be provided after the ejection waveform of the final drop. The drive waveform WW2 shown in FIG. 7 includes the non-ejection pulse PF having the expansion element that expands the pressure chamber 125 and the contraction element that is set to the intermediate voltage after the expansion after the damping pulse (Pdn) of the n-th drop. For example, the non-ejection pulse PF is set to a condition in which the liquid is not ejected from the nozzle 111, and for example, the pulse width is set to be sufficiently smaller than AL. In addition, the pulse width of each portion in the drive waveform can be appropriately changed, and for example, in the drive waveform WW2 shown in FIG. 6, the ejection pulse D4 is 1.2 AL.

It is not excluded to provide a delay time shorter than the intermediate time Tm in the waveforms up to the (n−1)-th drop.

An example is described in which the plurality of ejection pulses have the same pulse width and are rectangular waves, but the disclosure is not limited thereto. For example, the waveform may be a step waveform in which the voltage is switched stepwise, or may be a trapezoidal waveform.

A voltage value applied to each piezoelectric element 121 can be appropriately adjusted according to various conditions. For example, a potential difference may be generated by grounding one of adjacent piezoelectric elements 121 and applying a voltage to the other piezoelectric element 121, or a potential difference may be generated by applying voltages to both of the adjacent piezoelectric elements 121.

For example, the liquid ejection head 10 including the driver 15 is exemplified as an example of the drive device, but the disclosure is not limited thereto. For example, various control devices such as a control device of an ink jet recording apparatus connected to the liquid ejection head 10 and provided outside the liquid ejection head 10 may be used as the drive device.

The configuration of the liquid ejection head 10 is not limited to the above examples, and the liquid ejection head 10 may be used in a head of another type. For example, the ink jet head is not limited to a configuration in which the pressure chamber 125 is formed between a plurality of columnar piezoelectric elements 121, and can be applied to various other configurations such as a type in which the vibration plate provided between the pressure chamber 125 and the piezoelectric elements 121 vibrates due to the deformation of the piezoelectric element 125.

The ink jet head may be a non-recirculation type head that does not recirculate ink, or may be a recirculation type head that recirculates ink.

Each potential of the drive waveform may be changed, and a voltage value applied to each piezoelectric element 121 may be appropriately adjusted according to various conditions. The piezoelectric element 121 may expand if a voltage is increased and contract if the voltage is reduced, or may expand if the voltage is reduced and contract if the voltage is increased. The order of expansion and contraction in each ejection pulse may also be appropriately set according to various conditions.

The drive waveform is not limited to a pull-ejection waveform, but may be a push-ejection waveform or a push-pull-ejection waveform.

For example, the configuration of the liquid ejection head 10 is not limited to the above example, and the liquid ejection head 10 may be used in a head of another type. For example, the liquid ejection head 10 may drive a liquid ejection unit by causing vibration of a vibration plate provided between the pressure chamber 125 and the drive element unit by deforming a drive element unit. In addition, a structure in which the ink is ejected by electrostatically deforming a diaphragm, or a heating element type structure in which the ink is ejected from a nozzle using thermal energy of a heater or the like may be employed. In these cases, the diaphragm, the heater, or the like serves as an actuator for applying the pressure vibration to the inside of the pressure chamber 125.

The liquid ejection device 100 is exemplified as an ink jet printer that forms a two-dimensional image with ink on an image forming medium, but is not limited thereto. For example, the liquid ejection device 100 may be a 3D printer, an industrial manufacturing machine, or a medical machine. The liquid ejection device 100 may form a three-dimensional object by ejecting, for example, a material substance or a binder for solidifying the material from an ink jet head.

According to at least one embodiment described above, it is possible to achieve both the landing accuracy and the reduction of the satellite mist.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure in the claims and equivalents thereof.

What is claimed is:

1. A liquid ejection head comprising:
a nozzle plate including a nozzle;
a pressure chamber that is capable of storing liquid and communicates with the nozzle, a volume of the pressure chamber being varied to eject the liquid from the nozzle;
an actuator configured to vary the volume of the pressure chamber in response to a drive signal; and
a drive circuit configured to generate the drive signal, wherein
the drive signal includes n ejection waveforms (n is an integer of 2 or more) each including an ejection pulse for ejecting the liquid, the ejection pulse including an expansion portion for expanding the volume of the pressure chamber and a contraction portion that is subsequent to the expansion portion for contracting the volume of the pressure chamber,
at least one of the ejection waveforms includes a damping pulse that is subsequent to the ejection pulse and includes a contraction portion for contracting the volume of the pressure chamber and an expansion portion that is subsequent to the contraction portion for expanding the volume of the pressure chamber, and
the ejection waveforms include consecutive ejection waveforms that are separated by an intermediate time period that is in a range of 0.2 times or more and 2 times or less a half cycle of a natural vibration period of the liquid in the pressure chamber.

2. The liquid ejection head according to claim 1, wherein
a pulse width (Pd1) of a damping pulse of a first ejection waveform, a pulse width (Pdm) of a damping pulse of one of second through (n−1)-th ejection waveforms, and a pulse width (Pdn) of a damping pulse of an n-th ejection waveform satisfy
Pdn>Pd1>Pdm≥0.

3. The liquid ejection head according to claim 1, wherein
the ejection pulse of an n-th ejection waveform is longer than the ejection pulses of first through (n−1)-th ejection waveforms.

4. The liquid ejection head according to claim 1, wherein
the drive signal includes a non-ejection pulse that is subsequent to a damping pulse of an n-th ejection waveform and includes an expansion portion for expanding the volume of the pressure chamber and a contraction portion that is subsequent to the expansion portion for contracting the volume of the pressure chamber.

5. The liquid ejection head according to claim 1, wherein
the drive signal includes, in the intermediate time period, a boost pulse including a contraction portion for contracting the volume of the pressure chamber and an expansion portion that is subsequent to the contraction portion for expanding the volume of the pressure chamber.

6. The liquid ejection head according to claim 1, wherein
the expansion portion of the ejection pulse decreases a value of a voltage applied to the actuator from a first value to a second value, and
the contraction portion of the ejection pulse increases the value of the voltage applied to the actuator from the second value to the first value.

7. The liquid ejection head according to claim 6, wherein
the contraction portion of the damping pulse increases the value of the voltage applied to the actuator from the first value to a third value, and
the expansion portion of the damping pulse decreases the value of the voltage applied to the actuator from the third value to the first value.

8. The liquid ejection head according to claim 1, wherein
at least a first ejection waveform and an n-th ejection waveform include the damping pulse.

9. The liquid ejection head according to claim 8, wherein
a pulse width of the damping pulse of the n-th ejection waveform is longer than the intermediate time period.

10. The liquid ejection head according to claim 9, wherein
a pulse width of the damping pulse of the first ejection waveform is shorter than the intermediate time period.

11. A method for ejecting liquid from a liquid ejection head that includes:
a nozzle plate including a nozzle,
a pressure chamber that is capable of storing liquid and communicates with the nozzle, a volume of the pressure chamber being varied to eject the liquid from the nozzle, and
an actuator configured to vary the volume of the pressure chamber in response to a drive signal, the method comprising:
generating the drive signal that includes n ejection waveforms (n is an integer of 2 or more) each including an ejection pulse for ejecting the liquid, the ejection pulse including an expansion portion for expanding the volume of the pressure chamber and a contraction portion that is subsequent to the expansion portion for contracting the volume of the pressure chamber, wherein
at least one of the ejection waveforms includes a damping pulse that is subsequent to the ejection pulse and includes a contraction portion for contracting the volume of the pressure chamber and an expansion portion that is subsequent to the contraction portion for expanding the volume of the pressure chamber, and
the ejection waveforms include consecutive ejection waveforms that are separated by an intermediate time period that is in a range of 0.2 times or more and 2 times or less a half cycle of a natural vibration period of the liquid in the pressure chamber.

12. The method according to claim 11, wherein
a pulse width (Pd1) of a damping pulse of a first ejection waveform, a pulse width (Pdm) of a damping pulse of one of second through (n−1)-th ejection waveforms, and a pulse width (Pdn) of a damping pulse of an n-th ejection waveform satisfy Pdn>Pd1>Pdm≥0.

13. The method according to claim 11, wherein
the ejection pulse of an n-th ejection waveform is longer than the ejection pulses of first through (n−1)-th ejection waveforms.

14. The method according to claim 11, wherein
the drive signal includes a non-ejection pulse that is subsequent to a damping pulse of an n-th ejection waveform and includes an expansion portion for expanding the volume of the pressure chamber and a contraction portion that is subsequent to the expansion portion for contracting the volume of the pressure chamber.

15. The method according to claim 11, wherein
the drive signal includes, in the intermediate time period, a boost pulse including a contraction portion for contracting the volume of the pressure chamber and an expansion portion that is subsequent to the contraction portion for expanding the volume of the pressure chamber.

16. A liquid ejection device comprising:
a plurality of conveyance rollers configured to convey a medium; and
a liquid ejection head configured to eject liquid to the medium conveyed by the conveyance rollers, the liquid ejection head including:
a nozzle plate including a nozzle,
a pressure chamber that is capable of storing liquid and communicates with the nozzle, a volume of the pressure chamber being varied to eject the liquid from the nozzle,
an actuator configured to vary the volume of the pressure chamber in response to a drive signal, and
a drive circuit configured to generate the drive signal, wherein
the drive signal includes n ejection waveforms (n is an integer of 2 or more) each including an ejection pulse for ejecting the liquid, the ejection pulse including an expansion portion for expanding the volume of the pressure chamber and a contraction portion that is subsequent to the expansion portion for contracting the volume of the pressure chamber,
at least one of the ejection waveforms includes a damping pulse that is subsequent to the ejection pulse and includes a contraction portion for contracting the volume of the pressure chamber and an expansion portion that is subsequent to the contraction portion for expanding the volume of the pressure chamber, and
the ejection waveforms include consecutive ejection waveforms that are separated by an intermediate time period that is in a range of 0.2 times or more and 2 times or less a half cycle of a natural vibration period of the liquid in the pressure chamber.

17. The liquid ejection device according to claim 16, wherein
a pulse width (Pd1) of a damping pulse of a first ejection waveform, a pulse width (Pdm) of a damping pulse of one of second through (n−1)-th ejection waveforms, and a pulse width (Pdn) of a damping pulse of an n-th ejection waveform satisfy Pdn>Pd1>Pdm≥0.

18. The liquid ejection device according to claim 16, wherein
the ejection pulse of an n-th ejection waveform is longer than the ejection pulses of first through (n−1)-th ejection waveforms.

19. The liquid ejection device according to claim 16, wherein
the drive signal includes a non-ejection pulse that is subsequent to a damping pulse of an n-th ejection waveform and includes an expansion portion for expanding the volume of the pressure chamber and a contraction portion that is subsequent to the expansion portion for contracting the volume of the pressure chamber.

20. The liquid ejection device according to claim 16, wherein
the drive signal includes, in the intermediate time period, a boost pulse including a contraction portion for contracting the volume of the pressure chamber and an expansion portion that is subsequent to the contraction portion for expanding the volume of the pressure chamber.
